(19) United States
(12) Patent Application Publication
(10) Pub. No.: US 2005/0067905 A1
(43) Pub. Date: Mar. 31, 2005

(54) Stator cooling method and apparatus

(76) Inventors: Mark Maney, Simpsonville, SC (US); William Martin, Greenville, SC (US); Thomas Evon, Easley, SC (US); Qimin Dong, Greer, SC (US)

Correspondence Address: Alexander M. Gerasimow;Allen-Bradley Company, LLC, 1201 South Second Street, Milwaukee, WI, 53204-2496, US

(21) Appl. No.: 10/675,539

(22) Filed: Sep. 30, 2003

(51) Int. Cl. H02K 9/00; H02K 3/24; H02K 5/20

(52) U.S. Cl. 310/58; 310/216; 310/64

(57) ABSTRACT

According to one embodiment of the present technique, forced air (i.e., air flow) is routed through a motor stator having corners and center ducts. Advantageously, by routing the air flow through ducts in accordance with the present technique, air flow is more evenly distributed throughout the motor, thereby reducing hotspots. By way of example, the motor stator my include fins that affect air flow and provide heat dissipation surfaces to the motor.

### BACKGROUND OF THE INVENTION

The present invention relates generally to the field of electric motors and to methods and apparatus for cooling electric motors. More particularly, the invention relates to a novel technique for dissipating heat in the motor by directing forced air flow through the motor.

Electric motors of various types are commonly found in industrial, commercial and consumer settings. In industry, such motors are employed to drive various kinds of machinery, such as pumps, conveyors, compressors, fans and so forth, to mention only a few. Conventional alternating current electric (ac) motors may be constructed for single or multiple phase power, and are typically designed to operate at predetermined speeds, such as 3600 rpm, 1800 rpm, 1200 rpm, and so on. Such motors generally include a stator, comprising a multiplicity of coils, surrounding a rotor, which is supported by bearings for rotation in the motor frame. In the case of ac motors, ac power applied to the motor causes the rotor to rotate within the stator. The speed of this rotation is typically a function of the frequency of ac input power (i.e., frequency) and of the motor design (i.e., the number of poles defined by the stator windings). A rotor shaft extending through the motor housing takes advantage of this produced rotation and translates the rotor's movement into a driving force for a given piece of machinery. That is, rotation of the shaft drives the machine to which it is coupled.

During operation, conventional motors typically generate heat. Indeed, physical interaction of the motor's various moving components may produce heat by way of friction. Additionally, the electric current passing through the coil windings in the stator and rotor also produces heat, by way of resistive heating, for example. If left unabated, excess heat may degrade the performance of the motor. Worse yet, excess heat may contribute to any number of malfunctions, which may lead to system downtime and require maintenance. Undeniably, reduced efficiency and malfunctions are undesirable events that may lead to increased costs.

To dissipate heat, many conventional motors are equipped with fans configured to generate air flow (i.e., forced flow) through the motor housing for convective cooling of the motor. For example, the rotor shaft may include a fan that forces flow (i.e., air flow) through the interior of the motor, thereby convectively cooling the motor, particularly the stator and rotor. Typically, passageways formed in the stator of the motor route the air flow through the motor.

Unfortunately, typical motor designs do not efficiently distribute air flow through the motor. Air flow, in conventional motors, tends to affect disproportionately the areas and volumes in proximity to the air flow. Accordingly, air flow tends to affect only the areas proximately surrounding the passageway through which the air flow is directed. Moreover, air flow, because of its tendency to follow the path of least resistance, may be usurped by the certain passageways, as of function of the passageway profile, leaving little or no air flow to pass through the remaining passageways, thereby effectively vitiating any cooling effect via these passages. In other words, little or no air flow results through certain passages, thereby leading to an inefficient distribution and use of the air flow. Uneven air flow may lead to large variations in operating temperatures at various locations in the motor. Such variations are generally known as hotspots. Hotspots generally indicate that cooling resources are not being efficiently employed. Moreover, localized high operating temperatures (i.e., hotspots), sustained over a relatively long period of time, may lead to premature malfunction of the given location.

There is a need, therefore, for an improved technique for cooling an electric motor. Moreover, there is a particular need for a technique that reduces temperature variations in the motor and improves cooling air flow in the motor.

### SUMMARY OF THE INVENTION

The present invention provides an improved technique for cooling electric motors. The technique may be applied in a wide range of settings, but is particularly well suited for use in industrial, ac motors having a laminated construction. In one exemplary embodiment of the present technique, a lamination having a plurality of cooling ducts is provided. The lamination presents a generally square cross section having chamfered corners. Disposed in each of these chamfered corners is a corner duct that facilitates convective cooling of the motor during operation. Additionally, the lamination includes center ducts disposed about the vertical and horizontal centerlines of the lamination. When installed into a motor, the center ducts also facilitate convective cooling of the motor during operation thereof.

According to another embodiment, the present technique provides a lamination having corner ducts located in each of the chamfered corners. Additionally, the exemplary lamination includes at least one fin disposed in each of the corner ducts. Advantageously, the fin improves air flow distribution through the motor and provides additional cooling proprieties. For example, the fins may draw in heat from the air flow, thereby increasing the air flow capacity to draw heat away from the stator.

According to another exemplary embodiment, the present technique provides a method of manufacturing a lamination for a motor. The method comprises forming a corner duct in each of the chamfered corners of the lamination and center ducts about the vertical and horizontal centerlines of the lamination.

According to another exemplary embodiment, the present technique provides a method of cooling a lamination motor. The method comprises providing a forced air flow to the laminate frame motor. The method also comprises routing the forced air flow through corner ducts respectively located in each of the chamfered corners of a lamination and through center ducts located about vertical and horizontal centerlines of the lamination. Advantageously, the exemplary technique distributes the cooling air flow throughout the motor, thereby efficiently cooling the motor.

### BRIEF DESCRIPTION OF THE DRAWINGS

The foregoing and other advantages and features of the invention will become apparent upon reading the following detailed description and upon reference to the drawings in which:

FIG. 1 is a perspective view of an electric motor having features in accordance with the present technique;

FIG. 2 is a perspective view of the frame housing and stator core of the electric motor introduced in FIG. 1 illustrating the rotor of the motor in an exploded position with respect to the stator of the motor;

FIG. 3 is an exploded perspective view of a series of adjacent laminations having features in accordance with the present technique;

FIG. 4 is a partial cross sectional view of one of the laminations in FIG. 3 taken along line 4-4; and

FIG. 5 is a bar graph illustrating changes in air flow induced by exemplary embodiments of the present technique.

### DETAILED DESCRIPTION OF SPECIFIC EMBODIMENTS

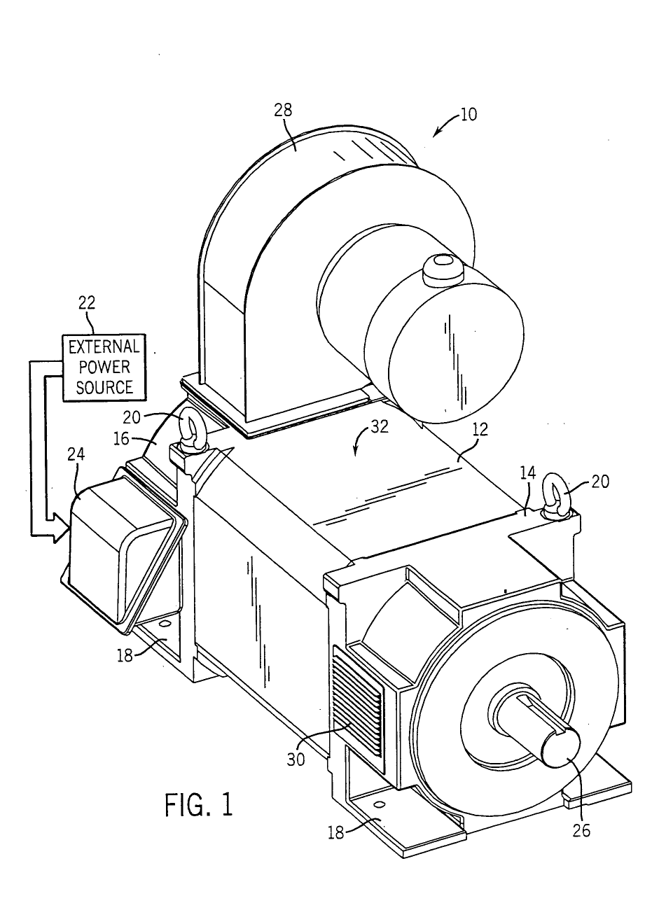

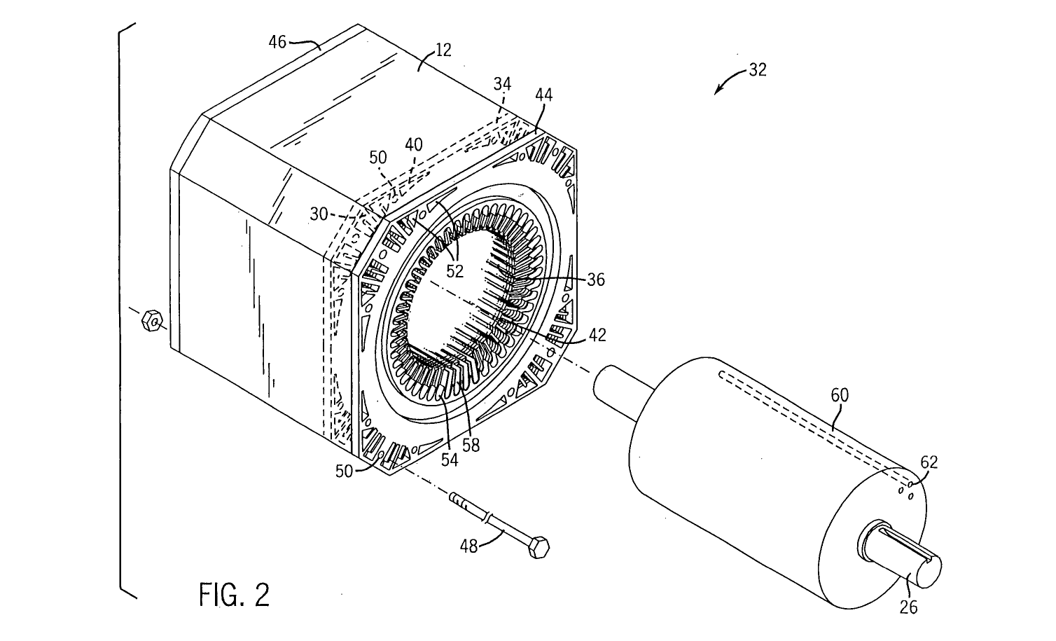

Turning to the drawings and referring first to FIG. 1, an exemplary electric motor 10 is shown. In the embodiment illustrated, the motor 10 is an induction motor housed in a conventional NEMA enclosure, which is generally employed in industrial settings. Although the present technique is described in relation to an industrial application, it may also be applied to any number of modalities, such as, commercial and residential applications. The motor 10 comprises a frame housing 12 capped at each end by front and rear end-caps 14 and 16, respectively. The frame housing 12 presents a generally square cross section having chamfered corners to conform with the shape of the individual laminations (see FIG. 2) disposed therein. Advantageously, the end-plates 14 and 16 may include mounting and transportation features, such as mounting flanges 18 and eyehooks 20. The frame housing 12 working with the front and rear end-caps 14 and 16, form a protective shell for a stator and a rotor (see FIG. 2). The frame housing 12 and the front and rear end-caps 14 and 16 may be formed of any number of materials, such as steel, aluminum, or any other suitable structural material. Those skilled in the art will appreciate in light of the following description that a wide variety of motor configurations may employ the cooling techniques outlined below.

To induce rotation of the rotor, current is routed through coil windings (not shown) disposed in the stator. Coil windings are electrically interconnected to form groups, which are, in turn, interconnected in a manner generally known in the pertinent art. The coil windings are further coupled to terminal leads (not shown), which electrically connect the coil windings to an external power source 22, such as a 480 Vac three phase power or 110 Vac single phase power. The electrical connection between the terminal leads and the external power source may be housed in a conduit box 24. The conduit box 24 may be formed of a metal or plastic material, and, advantageously, provides access to certain electrical components of the motor 10. By routing electrical current from the external power source 22 through the coil windings, a magnetic field is produced that induces rotation of the rotor, as is appreciated by those of ordinary skill in the pertinent art. A rotary shaft 26 coupled to the rotor also is forced to rotate. The rotor and shaft 26 may be supported in the frame by front and rear bearing sets (not shown) carried by the front and rear end-caps 14 and 16, respectively. As will be appreciated by those of ordinary skill in the art, the shaft 26 may be configured for coupling to any number of drive machine elements (not shown), thereby transmitting torque to the given machine element. By way of example, the rotational motion of the shaft may be harnessed to drive any number of machines, such as pumps, compressor, fans, conveyors and so forth.

During operation, the motor 10 may generate a substantial amount of heat. Particularly, the stator and rotor assemblies, during operation, may endure sustained periods of excess heat generation. For example, operating temperatures in the exemplary motor may reach upwards of 200C. If left unabated, such excess heat may lead to reductions in motor efficiency and, in certain instances, malfunctions. Accordingly, to cool the motor, a blower unit 28, such as a fan, may be included in the motor assembly. In the exemplary motor, the blower unit 28, located over the rear end-cap 16, draws in ambient air, pressurizes this air, and then forces the air through the frame housing 12, thereby creating an air flow. As discussed further below, the forced flow (i.e., air flow) convectively cools portions of the motor 10 by drawing heat from the motor 10 and venting it to the ambient environment external to the motor. The blower unit 28 may receive operating power from the external power source 22 via the conduit box 24. Alternatively, the blower unit 28 may include, by way of example, a generator capable of producing operating power independent of the external power supply 22. In either event, air taken in by the blower unit 28 may then be forced through the frame housing 12 to convectively cool the motor 10. Subsequently, the forced flow or air flow may be vented through a vent assembly 30 located in the front end-cap 14. Employing the rotation of the rotor itself may also generate air flow. For example, a fan may be disposed on the rotary shaft 26 internal to the end-caps 14 and 16.

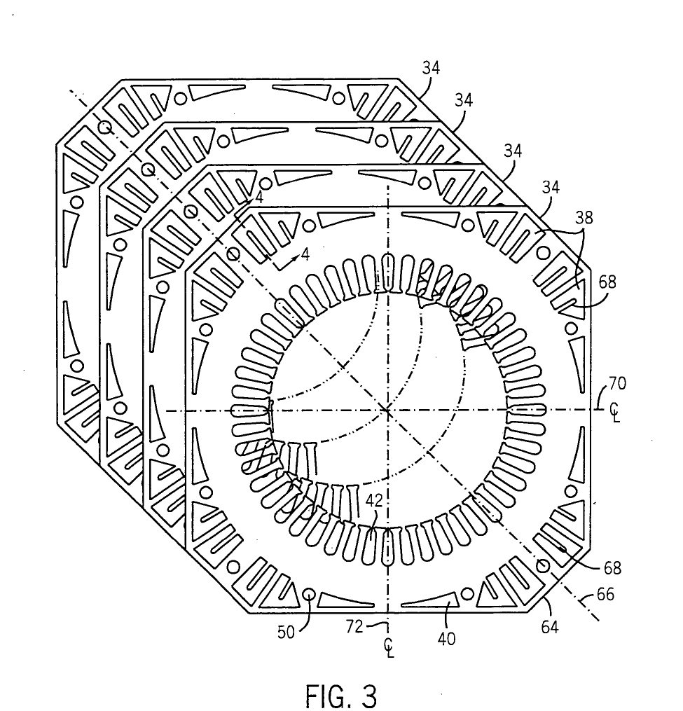

Because of the heat generated in the stator and rotor, much of the cooling effort may be focused on the central region 32 of the motor, as illustrated in FIG. 2. In the central region 32, the frame housing 12 carries a number of laminations 34, each having a generally square cross section with chamfered corners, that are stacked adjacent to one another. The laminations 34 may be formed of any number of materials, such as steel, aluminum, or any other suitably strong material. When appropriately aligned and maintained under pressure, as shown in FIG. 2, the laminations 34 cooperate to form a contiguous stator core 36. Advantageously, as discussed further in relation to FIG. 3, each lamination 34 may comprise features that align with the corresponding features of adjacently located laminations to amalgamate the given features into a contiguous element. For example, each lamination 34 may comprise cooling ducts, such as corner ducts 38 and center ducts 40, that cooperate with the cooling ducts of the adjacently located laminations 34 to form a continuous pathway for forced flow or air flow through the central region 32. As an additional feature, each lamination 34 may comprise slots 42 arranged in a circumferential pattern about an inner periphery of the lamination 34. Advantageously, the slots 42 of aligned, adjacent laminations 34 may be configured to receive the coil windings.

To maintain the pressure on the laminations 34, and to secure the laminations 34 in the frame housing 12, the central region 32 may include front and rear end-plates 44 and 46 having the same general dimensions as the laminations 34 and the housing 12. The end-plates 44 and 46 cooperate to hold the laminations 34 in a generally fixed position in the housing 12. In the illustrated embodiment, the end-plates 42 and 44 are fastened by through rods 48, which pass through corresponding alignment apertures 50 located on the end-plates 44 and 46 and laminations 34. The through rods 48 may be secured by any number of suitable fastening means, such as welding, bolts, rivets, and so forth, generally known to those of ordinary skill in the art. Additionally, the end-plates 44 and 46 may also comprise duct apertures 52 that work in cooperation with the cooling ducts 38 and 40 to route air flow through the frame housing 12, more particularly through the stator 36. Advantageously, the profiles of the duct apertures 52 may correspond with the profiles of the cooling ducts 38 and 40. However, other profiles of duct apertures 52 are envisaged. The end-plates 44 and 46 may also include a series of plate slots 54 disposed circumferentially about an inner periphery of the plate in a manner corresponding to the arrangement of the lamination slots 42. The plate slots 54 work in conjunction with the slots 42 of the laminations 34 to secure the coil windings in the stator 36. Advantageously, slot liners 58 may be disposed in each of the plate slots 56 and lamination slots 42 to protect and isolate the coil windings.

Located in the stator 36 of the exemplary motor is a rotor assembly 60. As discussed above, bearing sets (not shown) carry the rotor assembly 60 in the motor 10 and allow the rotor assembly 60 to rotate in response to the magnetic field produced by the stator coil windings, as is known to those of ordinary skill in the art. A gap defined by the space between the stator core 36 and the outer periphery of the rotor 60, routes air flow between the rotor 60 and stator 36, thereby cooling both portions of the rotor 60 and the stator 36. Additionally, the rotor 60 may include rotor ducts 62 that extend the length of the rotor 60 and route air flow through the rotor 60 to cool the interior region of the rotor 60.

Referring next to FIG. 3, a series of adjacent laminations 34 are illustrated in an exploded arrangement. As can be seen from the figure, each of the laminations 34 presents a generally square cross section having chamfered corners 64. In the exemplary motor, the corner ducts 38 are profiled so as to fit within the chamfered corners 64. Advantageously, by chamfering the corners 64, the overall weight of the motor 10 (see FIG. 1) is reduced and more even thermal properties are obtained. That is, the chamfered corners 64 remove unnecessary lamination material. A reduction in lamination material, such as steel or various other types of rigid metals, may also provide cost savings during manufacture. Moreover, as discussed further below, the profile of the corner ducts 64 in the chamfered corners improves air flow through the motor and contributes to eliminating or reducing hotspots.

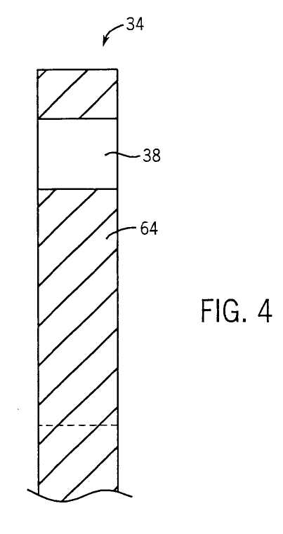

As discussed above, each of the corners 64 may include corner ducts 38. In the exemplary embodiment, each chamfered corner 64 includes two pairs of corner ducts 38 arranged in a mirror-image fashion about a diagonal axis 66 of the lamination 34. However, other arrangements, such as non-symmetric arrangements, and quantities, such as single (i.e., non-paired) configurations are also envisaged. Each corner duct 38 may also include one or more fins 68, which each extend the length of each lamination 34, as illustrated in FIG. 4. Advantageously, as discussed further below, the fins 68 may provide an enhanced surface area onto which heat in the air flow may be transferred. That is, each fin 68, by way of example, may act as a heat sink and heat flow channel, thereby increasing the convective cooling of the air flow within the motor 10. Additionally, as also further discussed below, the fins 68 may be configured to reapportion air flow in the housing 12 (see FIG. 2), thereby more beneficially cooling the motor 10.

Each lamination 34 may also include generally triangle-shaped center ducts 40, which in the exemplary embodiment are disposed in mirror-image arrangements about the horizontal and vertical centerlines 70 and 72 of the lamination. However, other arrangement and configurations for the center ducts 40 are also envisaged. For example, the discrete center ducts 40 about each centerline 70 and 72 may be combined into a single duct, or the center ducts 40 about each centerline 70 and 72 need not be arranged in a mirror-image fashion. Advantageously, as discussed further below, the center ducts 40 may be configured to distribute air flow throughout the motor 10 beneficially, thereby facilitating cooling the motor in a more uniform manner.

During operation, as discussed above in relation to FIG. 1, the blower unit 28 pressurizes ambient air and directs this air into the rear end-cap 16. In the exemplary embodiment, the pressurized air meets with the solid profile of the stator and the rotor, as illustrated in FIG. 2, and the end-cap 16 and is forced through the center and corner ducts 38 and 40, the gap between the rotor 60 and the stator 36, and the rotor ducts 58, thereby creating an air flow. As the pressurized air flows through the various ducts and passageways, heat in the various regions of the motor is drawn into the air flow and directed out of the motor 10 via the vent 30. The amount of heat drawn into the flow is a function of the flow rate and the respective temperatures, as is appreciated by those of ordinary skill in the art. The air flow, however, generally affects the regions of the motor in closest proximity to the flow. That is, air flowing through the corner ducts 38, for example, will have a greater impact on the corner 64 of the stator 36 than on the rotor 60. Along a similar vein, air flow through the rotor ducts 62 affects more the rotor 60, whereas air flow through the center ducts 40 affects more the center region of the stator 36. Accordingly, as discussed further below, by strategically reapportioning the air flow through the motor, more uniform cooling of the motor may be achieved. In particular, flow and therefore cooling, can be adjusted by appropriately designing and placing the ducts and passageways, including the size and configuration of ducts 38, 40, and 58, and fins 68.

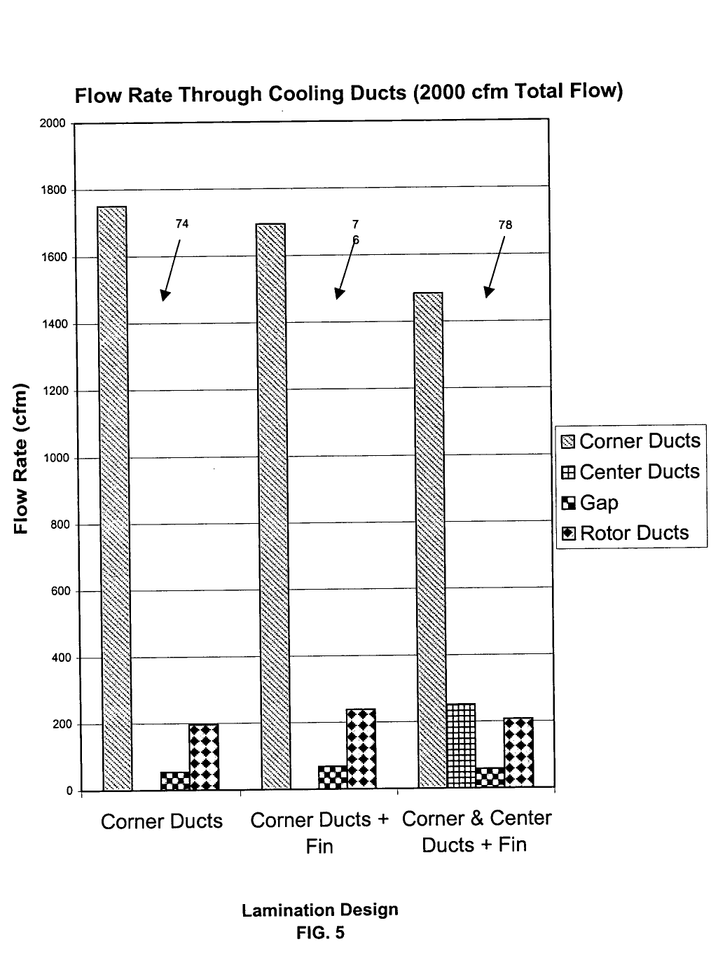

Turning next to FIG. 5, and keeping FIG. 2 in mind, the air flow through various duct arrangements of the exemplary motor 10 are illustrated in bar graph form. In the exemplary motor 10, the blower unit 28 produces 2000 cubic feet per minute (cfm) of air flow. However, those of ordinary skill in the art appreciate that the present technique may be applied to blower units providing any number of flow rates. Indeed, the present 2000 cfm flow rate is merely presented to illustrate the affect of the various duct configurations on the air flow rates through the motor. Moreover, those of skill in the art will appreciate that the air flow is routed through all of the various passages that is the total cfm through each of the ducts sums to 2000 cfm. The air flow data graphically presented in FIG. 5 is presented in tabular form below.

TABLE 1

| | Column 1 | Column 2 | Column 3 |
|---|---|---|---|
| | Corner Ducts | Corner Ducts + | Corner & Center |
| | (cfm) | Fin (cfm) | Ducts + Fin (cfm) |
| Corner Ducts | 1750 | 1694 | 1484 |
| Center Ducts | | | 251 |
| Gap | 54 | 68 | 58 |
| Rotor Ducts | 196 | 238 | 207 |

In Column 1 of Table 1, air flow through a motor having chamfered corners, corner ducts, and rotor ducts is represented. (It is worth note that the duct configuration represented in the Column 1 of Table 1 represents a lamination 34 without center ducts 40). Because the air tends to flow through the path of least resistance, the majority of the air flow will traverse through the larger corner ducts 38. By way of example, if the corner ducts 38 present a cross sectional area that is too large, all 2000 cfm of air flow will be effectively usurped by the corner ducts 38. That is, essentially no air flow will pass through the gap and the rotor ducts 62. Resultantly, all 2000 cfm of air flow through the housing 12 primarily affects the corners, thereby leading to hotspots in the motor 10. However, by chamfering the corners 64 of the laminations 34, the cross sectional area of the respective corner ducts 38 is reduced. That is, a portion of the 2000 (cfm) air flow is redirected, thereby reapportioning the air flow towards the remaining ducts (i.e., the rotor ducts and gap) in the motor 10, as represented by numeral 74 in FIG. 5. In such a configuration, at a load of 24 kilowatts (kW), the maximum temperature in the exemplary motor is 209C and the average temperature is 153C.

Turning to Column 2 of Table 1, air flow through an exemplary motor having an alternate duct configuration, particularly including fins 68 located in the corner ducts 38, is presented. Advantageously, the fins 68 direct a portion of the total air flow away from the corner ducts 38 and into rotor ducts 62 and gap. (It is worth note that the exemplary duct arrangement represented in Column 2 of Table 1 represents a lamination 34 without center ducts 40). By reapportioning the air flow as such, the cooling effect of the air flow may be more pervasive throughout the motor. That is, by directing a greater percentage of the air flow through the rotor ducts 62 and the gap, the effect of the air flow is more evenly distributed through the motor 10. Moreover, the fins 68 may also draw in heat from the air flow, thereby giving the air flow more convective heat capacity to cool the motor. The air flow distribution of this arrangement is represented by numeral 76 in FIG. 5. In the exemplary motor, at a load of 24 kW, the addition of the fins 68 in the corner ducts 38 reduces the maximum operating temperature 183C and the average operating temperature to 132C. Advantageously, the distribution of air through the motor 10, as such, reduces “hotspots” throughout the motor. Moreover, the cooling resources, e.g., the 2000 cfm of air flow, are more efficiently employed.

Turning to Column 3 of Table 1, air flow through an exemplary motor having corner ducts 38, rotor ducts 62, center ducts 40, and fins 68 is presented. As is depicted by the table, by adding center ducts 40 to the exemplary motor, which is operating at 24 kW, more of the air flow through the corner ducts 38 may be reapportioned to pass through the center ducts 40. Accordingly, the cooling effect of the air flow is more efficiently distributed throughout the motor. By adding ducts in the top, bottom, and sides of each frame 34, as well as by adding the fins 68 and the chamfered corners 64, more of the air flow may be apportioned to permeate the stator and rotor, thereby allowing more heat to be dissipated by the convective cooling effect of the air flow. The maximum operating temperature in the exemplary motor, which is operating at 24 KW, is reduced to 169C and the average operating temperature in the motor is reduced to 117C. Additionally, the redistribution of air flow from the corner ducts to the remaining passages reduces the “hotspots” in the motor.

While the invention may be susceptible to various modifications and alternative forms, specific embodiments have been shown in the drawings and have been described in detail herein by way of example only. However, it should be understood that the invention is not intended to be limited to the particular forms disclosed. Rather, the invention is to cover all modifications, equivalents, and alternatives falling within the spirit and scope of the invention as defined by the following appended claims.

1. A lamination for a motor stator, comprising:
a central aperture configured to receive a rotor;
a plurality of slots disposed concentrically about the central aperture for receiving a plurality of stator windings;
an outer periphery defining a generally square cross section having chamfered corners; and
a plurality of convective cooling ducts disposed between the slots and the outer periphery and extending longitudinally between ends of the lamination, the cooling ducts including at least one center duct disposed about vertical and horizontal centerlines of the frame, and at least one corner duct disposed in each of the chamfered corners between the center ducts.

2. The lamination as recited in claim 1, wherein the corner ducts include at least one fin for increasing a convective surface area within the corner ducts.

3. The lamination as recited in claim 1, comprising a plurality of corner ducts disposed in each of the chamfered corners.

4. The lamination as recited in claim 1, wherein the center ducts and the corner ducts are configured to force flow through the center ducts.

5. The lamination as recited in claim 1, wherein the center ducts and the corner ducts are configured to provide forced convective heat transfer from the lamination during operation to reduce overall temperature differentials in the lamination.

6. The lamination as recited in claim 1, wherein the at least one center duct includes a plurality of center ducts disposed at mirror-image locations about the respective vertical and horizontal centerlines of the frame.

7. A lamination for a motor stator for use in a motor, comprising:
a central aperture configured to receive a rotor;
a plurality of slots disposed concentrically about the central aperture for receiving a plurality of stator windings;
an outer periphery defining a generally square cross section having chamfered corners; and
a plurality of convective cooling ducts disposed between the slots and the outer periphery and extending longitudinally between ends of the lamination, the cooling ducts including at least one center duct disposed about vertical and horizontal centerlines of the frame, and at least one corner duct disposed in each of the chamfered corners between the center ducts, each of the corner ducts including at least one fin for increasing a convective surface area within the corner ducts;
wherein the center ducts and the corner ducts are configured to force flow through the center ducts.

8. The lamination as recited in claim 7, wherein each chamfered corner comprises at least four corner ducts.

9. The lamination as recited in claim 8, wherein the at least four corner ducts are arranged in a mirror-image configuration.

10. The laminate as recited in claim 7, wherein the center ducts and the corner ducts are configured to force flow through the center ducts.

11. The lamination as recited in claim 7, wherein the fins are configured to balance flow through the cooling ducts to reduce overall temperature differentials in the lamination during operation of the motor.

12. The lamination as recited in claim 7, wherein the center ducts and the corner ducts are configured to provide forced convective heat transfer from the lamination to reduce overall temperature differentials in the lamination during operation of the motor.

13. A motor comprising:
a laminate frame comprising a central aperture, a plurality of slots disposed concentrically about the central aperture for receiving a plurality of stator windings, an outer periphery defining a generally square cross section having chamfered corners, and a plurality of convective cooling ducts disposed between the slots and the outer periphery and extending longitudinally between ends of the lamination, the cooling ducts including at least one center duct disposed about vertical and horizontal centerlines of the lamination, and at least one corner duct disposed in each of the chamfered corners between the center ducts;
a rotor disposed in the central aperture of the lamination and supported for rotation therein; and
a fan configured to force convective air flow through the cooling ducts during operation.

14. The motor as recited in claim 13, wherein a gap is defined between the rotor and an inner periphery of the lamination, and wherein the cooling ducts are configured to force convective air flow through the gap during operation.

15. The motor as recited in claim 13, wherein the rotor includes a plurality of rotor cooling ducts extending longitudinally therethrough, and wherein the cooling ducts are configured to force convective air flow through the rotor cooling ducts during operation.

16. The motor as recited in claim 13, wherein the at least one corner duct includes at least one fin for increasing a convective surface area in the corner duct.

17. The motor as recited in claim 13, wherein the at least one center duct includes a plurality of center ducts disposed at mirror-image locations about the respective vertical and horizontal centerlines of the lamination.

18. The motor as recited in 13, wherein the corner ducts and center ducts are configured to force air flow through the center ducts.

19. A method of manufacturing a lamination for a motor stator, comprising:
forming a plurality of convective cooling ducts between an outer periphery of the lamination defining a generally square cross section having chamfered corners and a central aperture of the lamination, the cooling ducts including at least one center duct disposed about vertical and horizontal centerlines of the lamination, and at least one corner duct disposed in each of the chamfered corners between the center ducts.

20. The method as recited in claim 19, wherein the at least one corner duct includes at least one fin for increasing a convective surface area in the corner duct.

21. The method as recited in claim 19, wherein the at least one corner duct comprises a plurality of corner ducts disposed in each of the chamfered corners.

22. The method as recited in claim 19, wherein the center ducts include a plurality of center ducts disposed at mirror image locations about the respective vertical and horizontal centerlines of the lamination.

23. A method of cooling a motor comprising a plurality of laminations each having a central aperture configured to receive a rotor and an outer periphery defining a generally square cross section having chamfered corners, comprising:
providing a forced air flow to the laminate motor; and
routing the forced air flow through a plurality of convective cooling ducts located between the central aperture and the outer periphery, wherein the cooling ducts comprise at least one center duct disposed about vertical and horizontal centerlines of the lamination, and at least one corner duct disposed in each of the chamfered corners.

24. The method as recited in claim 23, wherein routing comprises forcing via the configuration of the center ducts and the corner ducts a portion of the air flow through the center ducts.

25. The method as recited in claim 23, wherein routing comprises forcing via the configuration of the center ducts and the corner ducts a portion of the air flow through a plurality of rotor cooling ducts located in the rotor.

26. The method as recited in claim 23, comprising dissipating heat in the air flow via at least one fin disposed in each of the corner ducts.

27. A method of cooling a motor comprising a plurality of laminations each having a central aperture configured to receive a rotor and an outer periphery defining a generally square cross section, comprising:
providing a forced air flow to the motor;
routing the forced air flow through a plurality of convective cooling ducts located between the central aperture and the outer periphery, wherein the cooling ducts comprise at least one center duct disposed about vertical and horizontal centerlines of the lamination, and at least one corner duct disposed in each of the corners; and
forcing via the configuration of the center ducts and the corner ducts a portion of the air flow through the center ducts.

28. The method as recited in claim 26, comprising balancing the air flow through the cooling ducts via the fin.

29. The method as recited in claim 23, comprising balancing the air flow through the cooling ducts via the configuration of the corner ducts and the center ducts.

30. The method as recited in claim 29, comprising forcing via the configuration of the center ducts and the corner ducts a portion of the air flow through a plurality of rotor ducts disposed in the rotor.

31. The method as recited in claim 29, comprising forcing via the configuration of the center ducts and the corner ducts a portion of the air flow through a gap defined between the rotor and an inner periphery of the frame.

32. The method as recited in claim 29, comprising balancing the air flow through the cooling ducts via the configuration of the corner ducts and the central ducts.

33. The method as recited in claim 32, comprising balancing the air flow through the cooling ducts via at least on fin disposed in at least one of the corner ducts.
